(19) United States
(12) Patent Application Publication
(10) Pub. No.: US 2010/0179771 A1
(43) Pub. Date: Jul. 15, 2010

(54) METHOD FOR ESTIMATING STABILITY OF STRUCTURE AGAINST BUOYANCY MOMENT

(76) Inventor: Jeong Bo SHIM, Bucheon-si (KR)

Correspondence Address: Jae Y. Park, Kile, Goekjian, Reed & McManus, PLLC, 1200 New Hampshire Ave. NW, Suite 570, Washington, DC, 20036, US

(21) Appl. No.: 12/568,106

(22) Filed: Sep. 28, 2009

(30) Foreign Application Priority Data
Jan. 14, 2009 (KR) 10-2009-0002864
Mar. 3, 2009 (KR) 10-2009-0017966

(51) Int. Cl. G06F 19/00; G01D 21/00

(52) U.S. Cl. 702/33

(57) ABSTRACT

Disclosed herein is a method for estimating the stability of a structure, which is capable of estimating the stability of the structure based on a buoyancy moment and resistance moment in consideration of the fact that the rotational uplift movement of the structure occurs. Here, the rotational uplift movement of the structure occurs earlier than the vertical uplift movement of the structure caused by a buoyant force.

### BACKGROUND OF THE INVENTION

1. Field of the Invention

The present invention relates to a method for estimating the stability of a structure against a buoyancy moment, and more particularly, to a structure stability estimation method capable of estimating the stability of a structure based on a buoyancy moment and resistance moment in consideration of the fact that the rotational uplift movement of the structure occurs.

2. Description of the Related Art

Generally, design of structures, such as, e.g., buildings or water treatment structures, has been accompanied by investigation of buoyancy stability. However, with respect to a buoyancy moment due to eccentricity between a dead load center and a buoyant force center, no investigation is being conducted at present.

This is because it has been difficult to clearly explain an application point of a resultant force of dead load and buoyant force, distribution of a reaction against the resultant force, determination of a rotation point of a structure, and rotational uplift movement of a structure.

As an example of a conventional buoyancy stability investigation method as shown in FIG. 1, a buoyancy safety factor F_{sb} may be set up as follows:

$${F}_{sb} = \frac{\sum {w}_{i}}{\sum {b}_{i}} \qquad ( 1 )$$

where, “wᵢ” is a dead load, and “bᵢ” is a buoyant force. With the use of the conventional buoyancy stability investigation method, however, it is impossible to confirm the rotational uplift movement of a structure caused by a buoyancy moment despite that the rotational uplift movement occurs earlier than the vertical uplift movement of the structure caused by the buoyant force. Therefore, it can be said that the conventional investigation method does not assure the stability of a structure. For this reason, there is a demand for a novel structure stability investigation method against a buoyancy moment.

### SUMMARY OF THE INVENTION

Therefore, the present invention has been made in view of the above problems, and it is an object of the present invention to provide a method for estimating the stability of a structure, which can estimate the stability of a structure in consideration of a buoyancy moment, for the sake of safe design of the structure.

In accordance with an aspect of the present invention, the above and other objects can be accomplished by the provision of a method for estimating the stability of a structure against a buoyancy moment including inputting modeling data of the structure using a commercial 3D modeling software or reading or revising previously prepared modeling, a rotating axis selecting operation for selecting a rotating axis based on the input data, calculating a safety factor, and estimating the stability of the structure by comparing the calculated safety factor with an allowable safety factor.

The rotating axis may be selected from among rotatable axes obtained by connecting respective neighboring two exterior angular points of an imaginary polygon to each other. Here, the imaginary polygon may correspond to the cross section of the structure drawn when the structure comes into contact with the ground surface.

In accordance with another aspect of the present invention, there is provided a method for estimating the stability of a structure against a buoyancy moment including a data input operation for inputting modeling data of the structure a commercial 3D modeling software, or reading or revising previously prepared modeling data, a rotating axis selecting operation for selecting a rotating axis, based on the input modeling data, from among rotatable axes obtained by connecting respective neighboring two exterior angular points of an imaginary polygon that corresponds to the cross section of the structure drawn when the structure comes into contact with the ground surface, a safety factor calculating operation for calculating a safety factor with respect to the selected rotating axis in consideration of a buoyancy moment and resistance moment, and a stability estimating operation for estimating the stability of the structure by comparing the calculated safety factor with a preset allowable safety factor.

The safety factor calculating operation may include a buoyancy moment calculating operation for calculating the buoyancy moment that causes the rotational uplift movement of the structure with respect to the selected rotating axis, calculating the resistance moment against the rotational uplift movement with respect to the selected rotating axis, and calculating the safety factor based on the calculated buoyancy moment and resistance moment.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a diagram illustrating a conventional method for estimating the stability of a structure against a buoyant force;

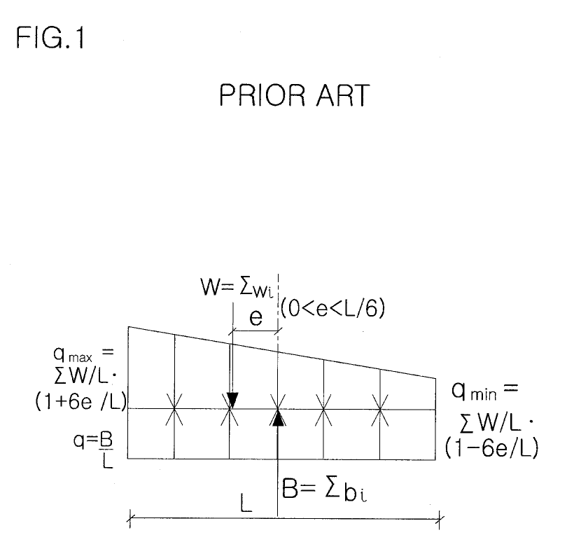

FIG. 2 is a flow chart illustrating a method for estimating the stability of a structure against a buoyancy moment according to an exemplary embodiment of the present invention; and

FIG. 3 is a partial plan view of a structure, illustrating a method for selecting a rotating axis of the structure according to the exemplary embodiment of the present invention.

### DETAILED DESCRIPTION OF THE INVENTION

Hereinafter, preferred embodiments of the present invention will be described in detail with reference to the accompanying drawings. In the following description of the present invention, a detailed description of known functions and configurations incorporated herein will be omitted when it may make the subject matter of the present invention rather unclear.

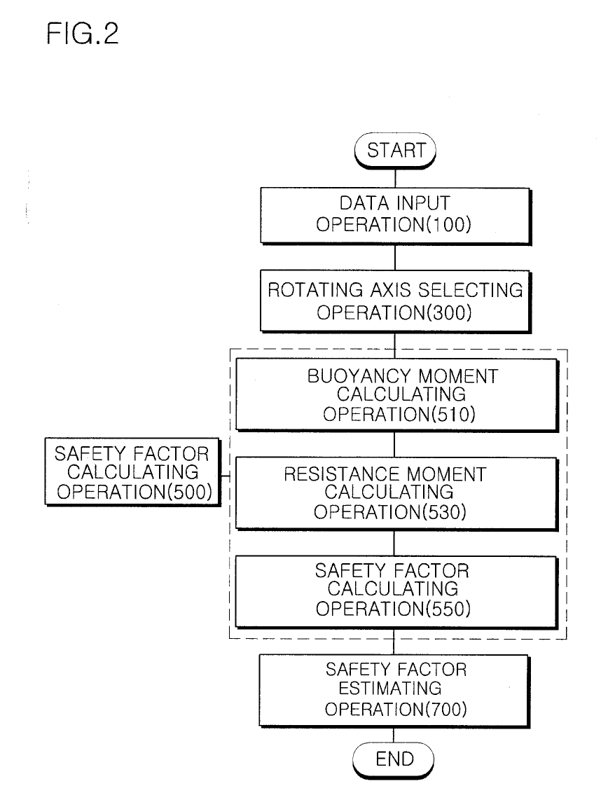

FIG. 2 is a flow chart illustrating a method for estimating the stability of a structure against a buoyancy moment according to an exemplary embodiment of the present invention. The stability estimation method according to the embodiment of the present invention includes: a data input operation 100 for inputting modeling data of a structure; a rotating axis selecting operation 300 for selecting a rotating axis using the input modeling data; a safety factor calculating operation 500 for calculating a safety factor with respect to the selected rotating axis in consideration of a buoyancy moment and load moment (resistance moment); and a stability estimating operation 700 for estimating the stability of the structure by comparing the calculated safety factor with a preset allowable safety factor.

Now, the above-described respective operations of the present invention will be described in more detail.

First, in the data input operation 100 for inputting modeling data of the structure, a user may input the modeling data of the structure a commercial 3D modeling software. Alternatively, the user may read the previously prepared modeling data, or revising the modeling data of the structure that are read. Then, in the rotating axis selecting operation 300, the rotating axis of the structure is selected from among a variety of rotatable axes obtained by connecting respective neighboring two angular points of an imaginary polygon to each other. Here, the imaginary polygon corresponds to the cross section of the structure drawn when the structure comes into contact with the ground surface. In the preparation of the modeling data, additionally, data producing methods, required to estimate the stability of the structure, are equal to well known conventional data producing methods and thus, a detailed description thereof will be omitted herein.

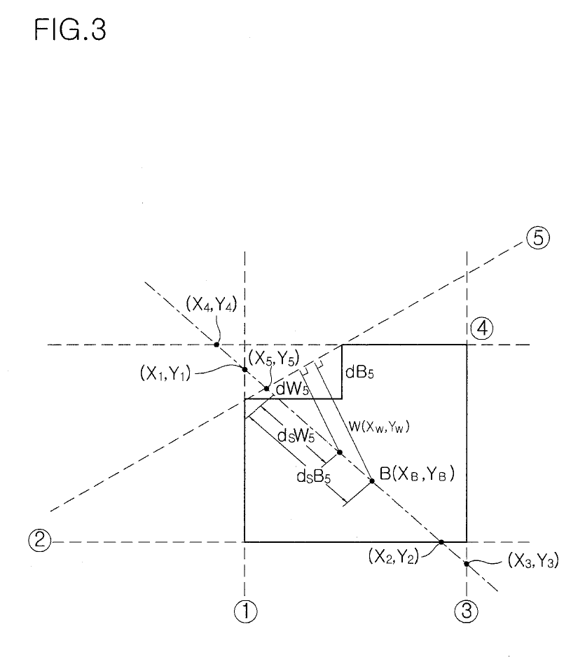

Next, in the rotating axis selecting operation 300, assuming that the imaginary polygon, which corresponds to the cross section of the structure drawn when the structure comes into contact with the ground surface, has an inwardly angled corner (e.g., 90 degrees), the—rotatable axes are limited to so-called exterior axes obtained by connecting the respective neighboring two exterior angular points of the imaginary polygon to each other except for an interior angular point of the inwardly angled corner. The shape of the imaginary polygon, i.e. the cross sectional shape of the structure, is defined by a boundary between the structure and the ground surface before or after a back filling process involved in the construction of the structure. For example, if the imaginary polygon has a shape as shown in FIG. 3 in plan view, there are five rotatable axes as candidates of the rotating axis (hereinafter, referred to as rotatable axes). More particularly, assuming that the imaginary polygon is a six-sided hexagonal polygon having a single inwardly angled corner as shown in FIG. 3, there exist five rotatable axes obtained by connecting neighboring two ones of five exterior angular points to each other except for a single interior angular point of the polygon. That is, in the case of two axes obtained by connecting the interior angular point to neighboring two exterior angular points of the polygon, extensions of the two axes penetrate through the cross section of the structure. In the present invention, the two axes are excluded from the rotatable axes.

In one rotating axis selecting method according to the present invention, all the rotatable axes may be selected as rotating axes.

In another rotating axis selecting method according to the present invention, as shown in FIG. 3, provided that a total dead load center (X_{w}, Y_{w}) and a total buoyant force center (X_{B}, Y_{B}) are given, we can obtain perpendicular distances (dWⱼ, dBⱼ) from the total dead load center (X_{w}, Y_{w}) and total buoyant force center (X_{B}, Y_{B}) to the respective five rotatable axes. Here, it is noted that the respective five rotatable axes do not penetrate through the cross section of the structure. Thereafter, by calculating values of dWⱼ/dBⱼ of the respective rotatable axes, one of the rotatable axes, the calculated result of which is the minimum, may be selected as the rotating axis. Alternatively, all the rotatable axes, whose the calculated results are not greater than 1, may be selected as rotating axes.

In another rotating axis selecting method according to the present invention, provided that a straight line connecting the total dead load center (X_{w}, Y_{w}) and total buoyant force center (X_{B}, Y_{B}) to each other is given, we can obtain intersection points (Xⱼ, Yⱼ) between the straight line and the respective five rotatable axes. Thereafter, the rotating axis is selected by comparing coordinate values of the intersection points (Xⱼ, Yⱼ) and the total dead load center (X_{w}, Y_{w}) with each other. For example, if the condition of X_{w}≦X_{B} is fulfilled, only one of the five rotatable axes, an Xⱼ value of the intersection point of which is the maximum of Xⱼ values that are not greater than an X_{w} value, may be selected as the rotating axis. Alternatively, all the rotatable axes whose Xⱼ values of the intersection points are not greater than the X_{w} value, may be selected as rotating axes. On the contrary, if the condition of X_{w}>X_{B} is fulfilled, only one of the five rotatable axes, an Xᵢ value of the intersection point of which is the minimum of Xᵢ values that are greater than the X_{w}, value, may be selected as the rotating axis. Alternatively, all the axes whose Xⱼ values of the intersection points are greater than the X_{w} value, may be selected as rotating axes.

In a further rotating axis selecting method according to the present invention, as shown in FIG. 3, after preparing the straight line connecting the total dead load center (X_{w}, Y_{w}) and total buoyant force center (X_{B}, Y_{B}) to each other and the intersection points (Xⱼ, Yⱼ) between the straight line and the respective five rotatable axes as shown in FIG. 3, we can obtain inclination distances (dₛWⱼ) between the respective intersection points and the total dead load center (X_{w}, Y_{w}) and inclination distances (dₛBⱼ) between the respective intersection points and the total buoyant force center (X_{B}, Y_{B}). Then, by calculating values of dₛWⱼ/dₛBⱼ of the respective rotatable axes, one of the rotatable axes, the calculated result of which is the minimum, may be selected as the rotating axis. Alternatively, all the axes whose the calculated results are not greater than 1, may be selected as rotating axes.

Once the rotating axis is selected via the above-described operation, subsequently, in the safety factor calculating operation 500, the safety factor with respect to the selected rotating axis is calculated in consideration of a buoyancy moment and load moment. For this, first, the buoyancy moment with respect to the selected rotating axis is calculated (510). Here, the buoyancy moment denotes a moment causing the rotational uplift movement of the structure with respect to the rotating axis.

The calculation of the total buoyancy moment is changed based on the selection of rotating axes. In the calculation of the total buoyancy moment, it is assumed that all the rotatable axes are selected as rotating axes. Firstly, the total buoyancy moment may be calculated using a perpendicular distance as follows:

M_{bj}=Σ(bᵢ×dbᵢⱼ) (2)

where, “bᵢ” is a buoyant force, “dbᵢⱼ” is a perpendicular distance from a buoyant force center to—the selected rotating axis. That is, the total buoyancy moment is calculated by multiplying each buoyant force by a perpendicular distance from each buoyant force center to the selected rotating axis and summing up different results of the selected rotating axis. Secondly, the total buoyancy moment, which causes the rotational uplift movement of the structure, may be calculated based on a perpendicular distance from the total buoyant force center to the selected rotating axis. This is represented as follows:

M_{bj}=(Σb_{I})×dBⱼ (3)

where, “bᵢ” is a buoyant force, “dBⱼ” is a perpendicular distance from the total buoyant force center to the selected rotating axis. Thirdly, the total buoyancy moment, which causes the rotational uplift movement of the structure, may be calculated based on an inclination distance from the total buoyant force center to the selected rotating axis. This is represented as follows:

M_{bj}=(Σb_{I})×dsBⱼ (4)

where, “bᵢ” is a buoyant force, “dsBⱼ” is an inclination distance from the total buoyant force center to the selected rotating axis.

Next, the total resistance moment (dead load moment) against the rotational uplift movement of the structure is calculated with respect to the selected rotating axis (530).

The calculation of the total resistance moment is also changed based on the selection of rotating axes. In the calculation of the total resistance moment, it is assumed that all the rotatable axes are selected as rotating axes. Firstly, the total resistance moment may be calculated using a perpendicular distance as follow:

Mᵣⱼ=Σ(w_{I}×dwᵢⱼ) (5)

where, “wᵢ” is a dead load, “dwᵢⱼ” is a perpendicular distance from a load center to the selected rotating axis. That is, the total resistance moment is calculated by multiplying each dead load by a perpendicular distance from each load center to the selected rotating axis and summing up different results of the selected rotating axis. Secondly, the total resistance moment may be calculated based on a perpendicular distance from the total dead load center to the selected rotating axis. This is represented as follows:

Mᵣⱼ=(Σw_{I})×dWⱼ (6)

where, “w_{I},” is a dead load, “dWⱼ” is a perpendicular distance from the total dead load center to the selected rotating axis. Thirdly, the total resistance moment may be calculated based on an inclination distance from the total dead load center to the selected rotating axis. This is represented as follows:

Mᵣⱼ=(Σw_{I})×dsWⱼ (7)

where, “wᵢ” is a dead load, “dsWⱼ” is an inclination distance from the total dead load center to the selected rotating axis.

Subsequently, the safety factor is calculated based on the total buoyancy moment and total resistant moment calculated via the above-described operations (550).

Here, the calculation of the safety factor is changed based on the selection of rotating axes.

For example, it is assumed that all the rotatable axes are selected as rotating axes. In this case, the safety factor may be calculated based on the total buoyancy moment and the total resistance moment with respect to the respective rotating axes.

This is represented as follows:

$${F}_{sj} = \frac{\sum ( {w}_{i} \times d {w}_{ij} )}{\sum ( {b}_{i} \times d {b}_{ij} )} \qquad ( 8 )$$

Secondly, the safety factor may be calculated based on the perpendicular distances from the total dead load center and total buoyant force center to the selected rotating axis. This is represented as follows:

$${F}_{sj} = \frac{( \sum {w}_{i} ) \times d {W}_{j}}{( \sum {b}_{i} ) \times d {B}_{j}} \qquad ( 9 )$$

Here, it is noted that the safety factor, calculated under the assumption that the rotating axis is selected based on the perpendicular distances from the total dead load center and total buoyant force center to the selected rotating axis, may be calculated in the same manner as the safety factor calculated under the assumption that all the rotatable axes are selected as the rotating axes and thus, is represented as follows:

$${F}_{sj} = \frac{\sum ( {w}_{i} \times d {w}_{ij} )}{\sum ( {b}_{i} \times d {b}_{ij} )} \qquad ( 10 )$$

That is, the two above-described safety factor calculation formulas may be adopted when the rotating axis is selected based on the perpendicular distances as described above.

Thirdly, even in the case where the rotating axis is selected using the intersection points as described above, the safety factor may be calculated by directly adopting the two above-described safety factor calculation formulas in which the rotating axis is selected using the perpendicular distances as described above.

Fourthly, the safety factor may be calculated based on the inclination distances from the total dead load center and total buoyant force center to the selected rotating axis. This is represented as follows:

$${F}_{sj} = \frac{( \sum {w}_{i} ) \times d {sW}_{j}}{( \sum {b}_{i} ) \times d {sB}_{j}} \qquad ( 11 )$$

In this case, similar to the case where the rotating axis is selected using the intersection points as described above, the two above-described safety factor calculation formulas may be directly adopted. That is, the safety factor may be calculated and represented as follows:

$$\begin{matrix}{F}_{sj} = \frac{( \sum {w}_{i} ) \times d {W}_{j}}{( \sum {b}_{i} ) \times d {B}_{j}} , or & ( 12 ) \\ {F}_{sj} = \frac{\sum ( {w}_{i} \times d {w}_{ij} )}{\sum ( {b}_{i} \times d {b}_{ij} )} & ( 13 )\end{matrix}$$

After calculating the safety factor with respect to the selected rotating axis as described above, the calculated safety factor is compared with a preset allowable safety factor, to estimate the stability of design of the structure (700).

For example, if there exist five rotatable axes and all the five rotatable axes are selected as rotating axes, five safety factor results are obtained. Then, the calculated safety factor of each rotating axis is compared with the allowable safety factor. If the respective calculated safety factors are not smaller than the allowable safety factor, the structure is estimated to be safe. However, if the calculated safety factor of at least one of the rotating axes is smaller than the allowable safety factor, the structure is estimated to be unstable and should be redesigned. Here, to allow a user to easily recognize the estimated result, the stability estimation operation 700 may display a message “OK” when the structure is estimated to be safe, or may display a message “N.G” when the structure is estimated to be unstable and should be redesigned.

Meanwhile, in the case where the rotating axis is selected using the perpendicular distances from the total dead load center and total buoyant force center to the selected rotating axis, using the intersection points as described above, or using the inclination distances as described above, only one minimum safety factor can be basically calculated. Accordingly, the user may easily estimate the stability of the structure by comparing the calculated minimum safety factor with the allowable stability factor.

As is apparent from the above description, according to the present invention, in consideration of the fact that the rotational uplift movement of a structure occurs, the stability of the structure can be estimated based on a buoyancy moment and resistance moment. This advantageously enables reasonable and safe design of the structure, which has been impossible with the conventional buoyancy investigation methods.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A method for estimating the stability of a structure against a buoyancy moment comprising:
a data input operation for inputting modeling data of the structure;
a rotating axis selecting operation for selecting a rotating axis using the input modeling data, the rotating axis being selected from among rotatable axes obtained by connecting respective neighboring two exterior angular points of an imaginary polygon that is defined by a boundary between the structure and the ground surface before or after a back filling process involved in the construction of the structure;
a safety factor calculating operation for calculating a safety factor with respect to the selected rotating axis in consideration of a buoyancy moment and resistance moment of the structure; and
a stability estimating operation for estimating the stability of the structure by comparing the calculated safety factor with a preset allowable safety factor.

2. The method according to claim 1, wherein the data input operation includes inputting the modeling data of the structure via a commercial 3D modeling software, reading the previously prepared modeling data, or revising the modeling data that are read.

3. The method according to claim 1, wherein the rotating axis selecting operation includes:
Selecting all the rotatable axes as rotating axes;
Selecting rotating axes by calculating perpendicular distances from a total dead load center and total buoyant force center to the respective rotatable axes, and calculating a value obtained by dividing the perpendicular distance from the total dead load center to each of the rotatable axes by the perpendicular distance from the total buoyant force center to each of the rotatable axes, so that one of the rotatable axes, the calculated result of which is the minimum, or all the rotating axes, whose the calculated results are not greater than 1, are selected as rotating axes;
Selecting rotating axes by calculating coordinate values of intersection points between a straight line that connects the total dead load center and total buoyant force center to each other and the respective rotatable axes, and comparing the coordinate values of the intersection points with the total dead load center with each other; or
Selecting rotating axes by calculating inclination distances between the intersection points and the total dead load center and between the intersection points and the total buoyant force center, and calculating a value obtained by dividing the inclination distance from the total dead load center to each of the rotatable axes by the inclination distance from the total buoyant force center to each of the rotatable axes, so that one of the rotatable axes, the calculated result of which is the minimum, or all of the rotatable axes whose, the calculated results are not greater than 1 are selected as rotating axes

4. The method according to claim 3, wherein the selection of rotating axes using the calculation of the coordinate values of the intersection points is implemented in such a manner that:
under the assumption that an X value of the total dead load center is not greater than an X value of the total buoyant force center, only one of the rotatable axes, an X value of the intersection point of which is the maximum of X values that are not greater than the X value of the total dead load center is selected as the rotating axis, or all the rotating axes whose X values of the intersection points are not greater than the X value of the total dead load center, are selected as rotating axes; and
under the assumption that the X value of the total dead load center is greater than the X value of the total buoyant force center, only one of the rotatable axes, an X value of the intersection point of which is the minimum of X values that are not smaller than the X value of the total dead load center, is selected as the rotating axis, or all the rotating axes whose X value of the intersection points are not smaller than the X value of the total dead load center, are selected as rotating axes.

5. The method according to claim 1, wherein the safety factor calculating operation includes:
calculating the total buoyancy moment that causes rotational uplift movement of the structure with respect to the selected rotating axis;
calculating the total resistance moment against the rotational uplift movement with respect to the selected rotating axis; and
calculating the safety factor based on the calculated total buoyancy moment and total resistance moment.

6. The method according to claim 5, wherein the calculation of the total buoyancy moment is implemented based on the selection of rotating axes in such a manner that:
under the assumption that all the rotatable axes are selected as rotating axes, the total buoyancy moment is calculated by multiplying each buoyant force by a perpendicular distance from each buoyant force center to the selected rotating axis and summing up different results of the selected rotating axis and is represented by
M_{bj}=Σ(b_{I}×dbᵢⱼ);
the total buoyancy moment is calculated based on a perpendicular distance from the total buoyant force center to the selected rotating axis and is represented by
M_{bj}=(Σbᵢ)×dBⱼ; or
the total buoyancy moment is calculated based on an inclination distance from the total buoyant force center to the selected rotating axis and is represented by
M_{bj}=(Σb_{I})×dsBⱼ.

7. The method according to claim 5, wherein the calculation of the total resistance moment is implemented based on the selection of rotating axes in such a manner that:
under the assumption that all the rotatable axes are selected as rotating axes, the total resistance moment is calculated by multiplying each dead load by a perpendicular distance from each load center to the selected rotating axis and summing up different results of the selected rotating axis and is represented by
Mᵣⱼ=Σ(w_{I}×dwᵢⱼ);
the total resistance moment is calculated based on a perpendicular distance from the total dead load center to the selected rotating axis and is represented by
Mᵣⱼ=(Σwᵢ)×dW_{J}; or
the total resistance moment is calculated based on an inclination distance from the total load center to the selected rotating axis and is represented by
Mᵣⱼ=(Σw_{I})×dsWⱼ.

8. The method according to claim 5, wherein:
the calculation of the safety factor is implemented based on the calculated total buoyancy moment and total resistance moment in such a manner that:
under the assumption that all the rotatable axes are selected as rotating axes, the safety factor is calculated using a total buoyancy moment and a total resistance moment with respect to the respective rotating axes and is represented by
$${F}_{sj} = \frac{\sum ( {w}_{i} \times d {w}_{ij} )}{\sum ( {b}_{i} \times d {b}_{ij} )} ;$$
under the assumption that the rotating axis is selected based on the perpendicular distances from the total dead load center and total buoyant force center to the respective rotatable axes, the safety factor is represented by
$${F}_{sj} = \frac{( \sum {w}_{i} ) \times d {W}_{j}}{( \sum {b}_{i} ) \times d {B}_{j}} ; or$$
the safety factor, obtained when the rotating axis is selected based on the perpendicular distances, is calculated in the same manner as the safety factor obtained when all the rotatable axes are selected as rotating axes, and is represented by
$${F}_{sj} = \frac{\sum ( {w}_{i} \times d {w}_{ij} )}{\sum ( {b}_{i} \times d {b}_{ij} )}$$

9. The method according to claim 5, wherein, under the assumption that the rotating axis is selected using the intersection points, the safety factor is calculated based on the perpendicular distances and is represented by
$$\begin{matrix}{F}_{sj} = \frac{( \sum {w}_{i} ) \times d {W}_{j}}{( \sum {b}_{i} ) \times d {B}_{j}} , or \\ {F}_{sj} = \frac{\sum ( {w}_{i} \times d {w}_{ij} )}{\sum ( {b}_{i} \times d {b}_{ij} )}\end{matrix}$$

10. The method according to claim 5, wherein the calculation of the safety factor is implemented in such a manner that:
the safety factor, calculated under the assumption that the rotating axis is selected using the inclination distances, is represented by
$${F}_{sj} = \frac{( \sum {w}_{i} ) \times d {sW}_{j}}{( \sum {b}_{i} ) \times d {sB}_{j}} ; or$$
the safety factor, calculated under the assumption that the rotating axis is selected using the inclination distances, is represented by
$${F}_{sj} = \frac{( \sum {w}_{i} ) \times d {W}_{j}}{( \sum {b}_{i} ) \times d {B}_{j}} , or$$
$${F}_{sj} = \frac{\sum ( {w}_{i} \times d {w}_{ij} )}{\sum ( {b}_{i} \times d {b}_{ij} )} .$$

11. The method according to claim 1, wherein the stability estimating operation includes:
calculating the safety factors with respect to the respective rotating axes when all the rotatable axes are selected as the rotating axes;
comparing the calculated safety factors with respect to all the rotating axes with the allowable safety factor; and
estimating the structure to be safe if the calculated safety factor results with respect to all the rotating axes are not smaller than the allowable safety factor, or estimating the structure to be unstable and be redesigned if the calculated safety factor result with respect to at least one of the rotating axes is smaller than the allowable safety factor.

12. The method according to claim 1, wherein the stability estimating operation is implemented to estimate the stability of the structure by comparing the allowable safety factor with only one or a number of safety factors calculated under the assumption that the rotating axis is selected using a perpendicular distance from a total dead load center and total buoyant force center to the rotating axis, using an intersection point between a straight line that connects the total dead load center to total buoyant force center and the rotating axis, or using an inclination distance between the intersection point and the total dead load center and an inclination distance between the intersection point and total buoyant force.
